(19) United States
(12) Patent Application Publication
(10) Pub. No.: US 2025/0001913 A1
(43) Pub. Date: Jan. 2, 2025

(54) CHILD CAR SEAT TO VEHICLE CONNECTOR

(71) Applicant: WonderFold Wagon, Irwindale, CA (US)

(72) Inventor: Che Yu Lin, New Taipei City (TW)

(21) Appl. No.: 18/388,134

(22) Filed: Nov. 8, 2023

(30) Foreign Application Priority Data
Jun. 28, 2023 (CN) 202321668666.5

(51) Int. Cl. B60N 2/28

(52) U.S. Cl. CPC B60N 2/2821

(57) ABSTRACT

A connector usable to fix a child seat to a vehicle is provided. The connector includes a bottom element configured to receive bottom element support members connectable to the vehicle, a top element positioned above the bottom element and configured to receive top element support members configured to receive the child seat, and a locking arrangement positioned between the bottom element and the top element, wherein the locking arrangement is configured to lock the top element to the bottom element and comprises a locking element configured to release and subsequently lock the top element such that the top element can rotate to an alternate orientation.

The present application claims priority based on Chinese Utility Model patent application No. 202321668666.5, filing date Jun. 28, 2023, entitled “A connector that can be used to fix an infant car seat on a stroller,” inventor Che Yu Lin, the entirety of which is incorporated herein by reference.

### BACKGROUND

### I. Field

The present invention relates to affixing a baby car seat to a pushcart, such as a stroller, and more particularly to baby carriers of varying construction that may be attached to a stroller using a connector.

### II. Description of the Related Art

Families with infants usually have baby strollers or wagons. Using these vehicles, adults are not required to carry children and the child can be maintained in a safe and comfortable position and can sit or lie in the stroller. The baby can be transported using the stroller making it very convenient for users to transport infants and young children when they go out.

In addition, many families have their own cars, and infants and young children typically require child car seats applicable to the size of the child. Such a child car seat can be fixed on a seat of an automobile, for example, typically with the aid of a seat belt.

When children are taken from the vehicle, the child is removed and the car seat may stay, or in some instances the child car seat may be removed and put in a stroller or other transporting device. However, unless the child seat is made to fit the stroller or transporting device or vehicle, it can be difficult to safely secure the child seat to the vehicle. Thus an infant car seat from manufacturer M may not fit with a stroller from manufacturer N, and may not even fit with every stroller made by manufacturer M. The question becomes how to integrate the safety seat with a variety of strollers, wagons, or vehicles,

It would therefore be beneficial to provide a connection between various infant and child car seats and strollers or other transporting vehicles that overcomes issues with prior child car seat and stroller, wagon, and vehicle designs.

### SUMMARY

The following presents a simplified summary in order to provide a basic understanding of some aspects of the claimed subject matter. This summary is not an extensive overview, and is not intended to identify key/critical elements or to delineate the scope of the claimed subject matter. Its sole purpose is to present some concepts in a simplified form as a prelude to the more detailed description that is presented later.

Thus according to one embodiment, there is provided a connector usable to fix a child seat to a vehicle. The connector includes a bottom element configured to receive bottom element support members connectable to the vehicle, a top element positioned above the bottom element and configured to receive top element support members configured to receive the child seat, and a locking arrangement positioned between the bottom element and the top element, wherein the locking arrangement is configured to lock the top element to the bottom element and comprises a locking element configured to release and subsequently lock the top element such that the top element can rotate to an alternate orientation.

According to a further embodiment, there is provided a connector usable to fasten a child seat to a vehicle. The connector comprises a bottom element configured to receive a plurality of bottom supports joined to a plurality of vehicle locking elements configured to lock the connector to the vehicle, a top element positioned above the bottom element and configured to receive a plurality of top supports joined to a plurality of child seat securing elements, and a locking arrangement positioned between the bottom element and the top element, wherein the locking arrangement is configured to lock the top element to the bottom element and comprises a locking element configured to release and subsequently lock the top element such that the top element is rotatable to a second orientation.

According to another embodiment, there is provided a connector joining a child seat to a vehicle. The connector comprises a bottom element configured to receive a plurality of bottom supports and a plurality of vehicle locking elements configured to lock the connector to the vehicle, a top element positioned above the bottom element and configured to receive a plurality of top supports joined and a plurality of child seat securing elements, and a locking arrangement configured to lock the top element to the bottom element and comprising a locking element configured to release and subsequently lock the top element such that the top element is rotatable to and lockable in a second orientation.

To the accomplishment of the foregoing and related ends, certain illustrative aspects are described herein in connection with the following description and the annexed drawings. These aspects are indicative, however, of but a few of the various ways in which the principles of the claimed subject matter may be employed and the claimed subject matter is intended to include all such aspects and their equivalents. Other advantages and novel features may become apparent from the following detailed description when considered in conjunction with the drawings.

### BRIEF DESCRIPTION OF THE DRAWINGS

FIG. 1 is a schematic structural diagram of a first embodiment of the connector;

FIG. 2 is an exploded view of the bottom element, the top element, and the rotating components of the first embodiment;

FIG. 3 is a further schematic structural diagram of a second embodiment of the connector;

FIG. 4 is an exploded view of the bottom element, the top element, and the rotating components of the second embodiment;

FIG. 5 is a side sectional view of a connector according to the present design;

FIG. 6 is a schematic diagram of the use of the connector;

FIG. 7 is a structural schematic diagram of the connector of the second embodiment of the present design rotated to a second orientation;

FIG. 8 is a bottom view of the connector of the second embodiment of the design;

FIG. 9 is a cutaway view showing connector components illustrating how the locking arrangement operates;

FIG. 10 shows the locking arrangement with locking element rotated to the left in this view;

FIG. 11 is a cutaway top view illustrating the locking element in a first position;

FIG. 12 is a cutaway top view illustrating the locking element in a second position;

FIG. 13 is a cutaway top view of the locking arrangement with the top element rotated; and

FIG. 14 illustrates an alternate bracket embodiment used to accommodate different child car seats.

### DETAILED DESCRIPTION

In this document, the words “embodiment,” “variant,” and similar expressions are used to refer to particular apparatus, process, or article of manufacture, and not necessarily to the same apparatus, process, or article of manufacture. Thus, “one embodiment” (or a similar expression) used in one place or context can refer to a particular apparatus, process, or article of manufacture; the same or a similar expression in a different place can refer to a different apparatus, process, or article of manufacture. The expression “alternative embodiment” and similar phrases are used to indicate one of a number of different possible embodiments. The number of possible embodiments is not necessarily limited to two or any other quantity.

The word “exemplary” is used herein to mean “serving as an example, instance, or illustration.” Any embodiment or variant described herein as “exemplary” is not necessarily to be construed as preferred or advantageous over other embodiments or variants. All of the embodiments and variants described in this description are exemplary embodiments and variants provided to enable persons skilled in the art to make or use the invention, and not to limit the scope of legal protection afforded the invention, which is defined by the claims and their equivalents.

Described embodiments are only some of the embodiments of the present invention, not all of them. If directional indications are provided (such as up, down, left, right, front, back, top, bottom, inner, outer, vertical, transverse, longitudinal, counterclockwise, clockwise, circumferential, radial, axial . . . ), the directional indication is only used to explain the relative positional relationship, movement conditions, etc. When the specific posture changes, the directional indication also changes accordingly.

A description related to “the first” or “the second” etc. in an embodiment are for descriptive purposes only and are not to be construed as indicating or implying their relative importance or implying the number of technical characteristics indicated. Thus, features defined as “first” and “second” may expressly or implicitly include up to one or more fewer features. In addition, the technical solutions of the various embodiments can be combined with each other.

The present design provides a connector which can be used to fix an infant car seat on a movable vehicle such as a stroller or wagon. The term infant seat, baby seat, car seat, are used herein and indicate a seat used to receive a child and be secured in a vehicle such as an automobile. Also as used herein, the term stroller, wagon, or vehicle broadly indicates any type of device configured to receive the connector. Use of any of these terms is not intended to be in any way limiting.

The connector 1 comprises a top element 20 and a bottom element 10, each comprising multiple elements including rotating elements, fixed parts, and buckle parts for securing the connector to a vehicle. The top element 20 and bottom element 10 may be locked together via locking elements associated with rotating component elements, enabling the top element 20 to rotate relative to the base or bottom element 10 from a first orientation to a second orientation different from the first orientation. The buckle parts can provide a lockable connection enabling connection to or buckling the connector on, for example, a frame of a vehicle such as a baby stroller or wagon. Such attachability enables connecting and/or affixing the infant car seat to the vehicle. The connector provided can be installed with various brands of car seats and can connect one of the various brands of car seats to different types of wagons, strollers, and/or vehicles.

The installed car seat allows the infant to sit safely and comfortably in, for example, a stroller, and the connector can rotate 360 degrees such that the infant can be repositioned and have different fields of view. The present design thus provides a specialized connecting device that can fix the infant car seat on a device such as a wagon or stroller.

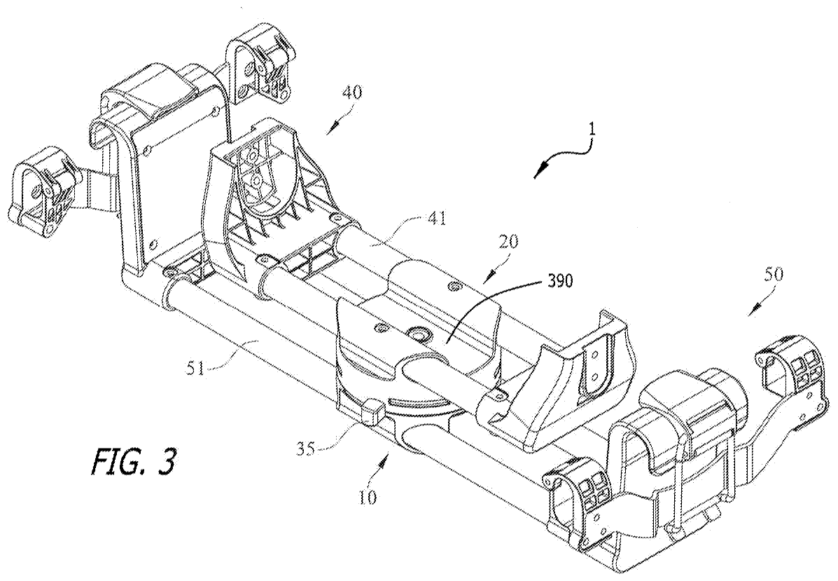

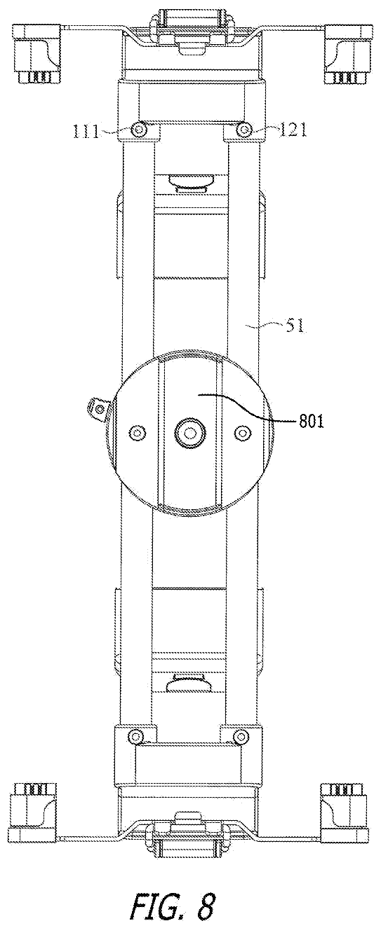

The connector includes in one embodiment a base, a top, a rotating element and at least one fixture. The base, such as bottom element 10, in one configuration includes at least one lower perforation 801 as shown in FIG. 8 and at least one upper perforation 390 as shown in FIG. 3. The at least one lower perforation 801 is provided on the bottom element 10, specifically on a lower surface, while the at least one upper perforation 390 is provided on an upper surface of the top element 20 in one embodiment.

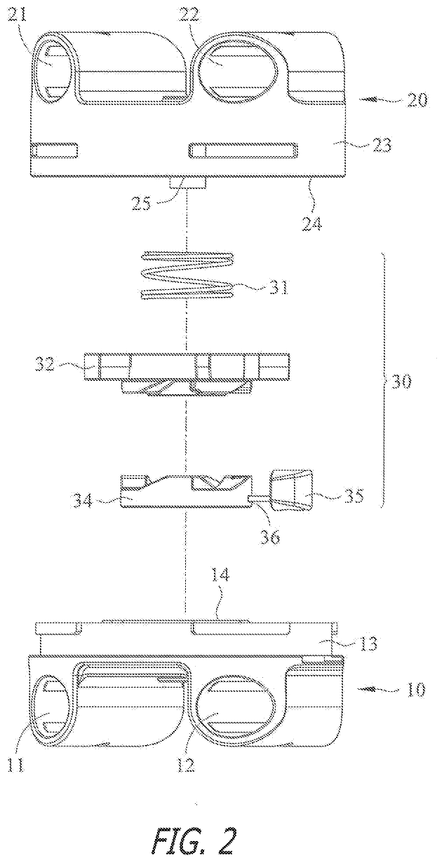

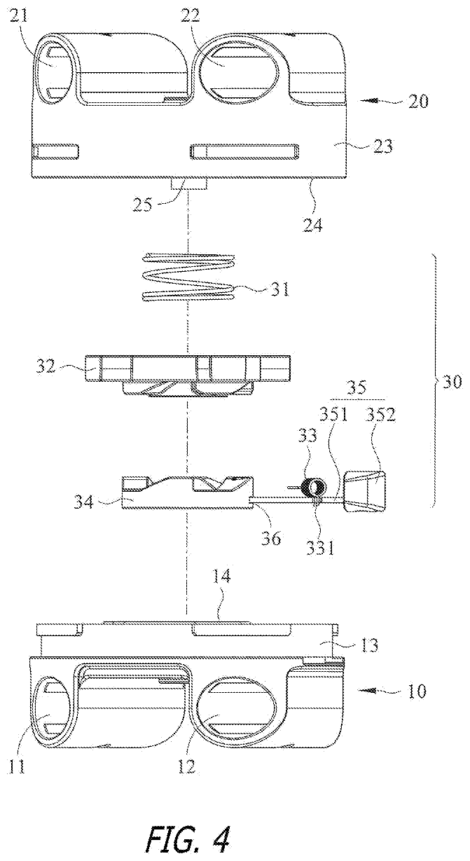

The top of connector 1 in one embodiment includes an upper base 23 and at least one upper perforation 390, screw holes 21 and 22, and upper groove 24, and shaft 25, the at least one upper perforation 390 provided on the upper surface, or “roof,” of the upper base 23. Upper groove 24 is located on a lower surface of the upper base 23 and receives turntable member 32 therein as shown in FIG. 3. Note the inner receiving groove, upper groove 24, is not visible in FIGS. 2 and 4, for example, but is typically a simple opening, either threaded or unthreaded, that allows receipt of and rotation of turntable member 32 therein.

A rotating arrangement in the form of rotating element 30 is provided and arranged between the bottom element 10 and the top element 20. As shown in FIG. 2, in one embodiment, the rotation element 30 includes compression spring 31, turntable member 32, buckle seat 32 and locking element 35. Compression spring 31 has one end sleeved on shaft 25 in the center of the lower surface of the top element 20. The other end of compression spring 31 is received on turntable member 32. Turntable member 32 is fitted in buckle seat 34, and the bottom of buckle seat 34 engages with bottom groove 14 provided at the top of bottom element 10. Locking element 35 is arranged on one side of a through hole 36 for releasing or locking or otherwise holding the rotation of the turntable member.

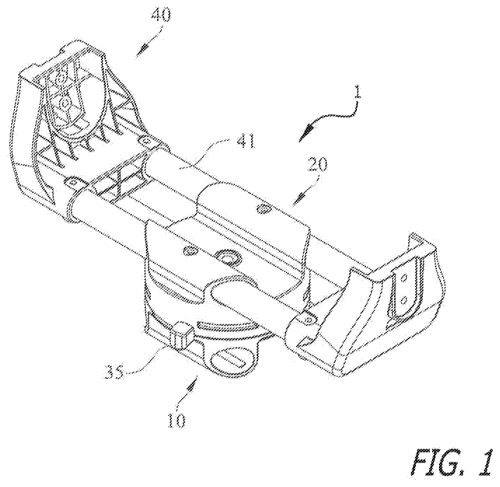

As shown in FIG. 1 for example, at least one upper cross bar 41 passes through the at least one upper through hole such as upper left hole 21 or upper right hole 22. The two ends of each upper cross bar of the at least one upper cross bar 41 pass through the at least one fixing piece 40, so that the at least one fixing piece 40 is adjacent to the top surface of top element 20. The infant car seat can be placed in a space formed by the at least one fixing member, i.e. between the two fixing pieces 40 shown in FIG. 1.

The connector thus operates to fix the infant car seat to the vehicle or stroller. The locking element 35 may permit turntable member 32 to be released. Turntable member 32 rotates, enabling the top element 20 to rotate relative to the bottom element from a first orientation to a second orientation different from the first orientation. The top configuration, including top element 20, is rotatable from zero to 360 degrees relative to the base or bottom element 10.

The connector 1 in one embodiment may include a bottom element 10, a top element 20, a rotation element 30, at least one fixing piece 40, and at least one buckle piece such as buckle seat 34, part of rotation element 30. The base or bottom element 10 includes at least one lower perforation 801. Also provided is upper groove 24 on the lower surface of top element 20. The top element 20 in this embodiment may include upper left hole 21, an upper base 23, and upper right hole 22, where support members pass through upper left hole 21 and upper right hole 22.

Rotating element 30 is arranged between the bottom element 10 and the top element 20. Rotating element 30 in one embodiment includes compression spring 31, a turntable member 32, and a locking element 35 provided with through hole 36 in buckle seat 34. One end of compression spring 31 is sleeved on shaft 25, which rotates when top element 20 rotates. Shaft 25 is generally positioned on the lower surface of top element 20. The other end of compression spring 31 may be sleeved on turntable member 32. The buckle of the infant car seat may be fastened or fixed with the bottom of turntable member 32 and the bottom of buckle seat 34 operates with bottom groove 14 of bottom element 10. Locking element 35 is arranged outside buckle seat 34 for releasing the top element 20 and enabling rotation of top element 20. In this embodiment, each fixing piece 40 is attached to at least one and typically two upper cross bars 41 through the holes provided in top element 20, such as upper left hole 21 and upper right hole 22. The two ends of each upper cross bar, such as upper cross bar 41, pass through the at least one fixing piece 40 so that the at least one fixing piece 40 and the top element 20 are arranged adjacently.

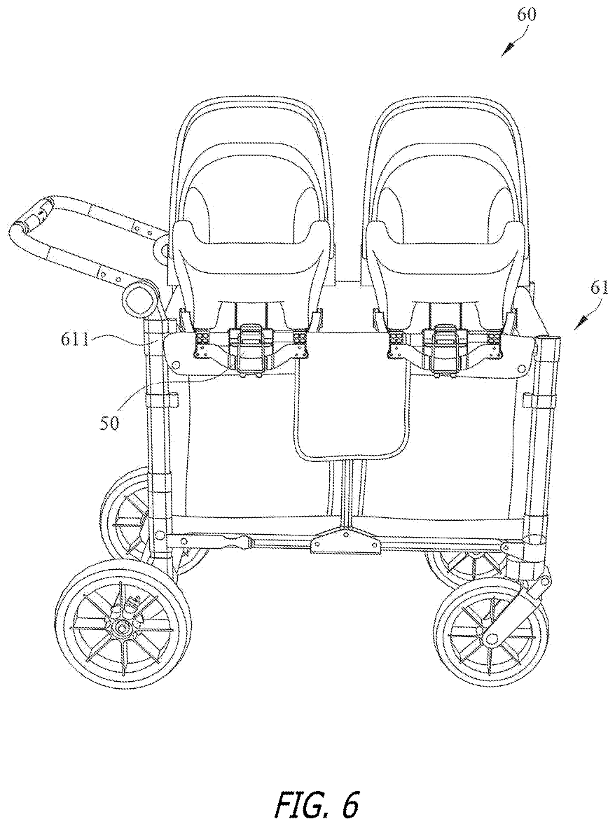

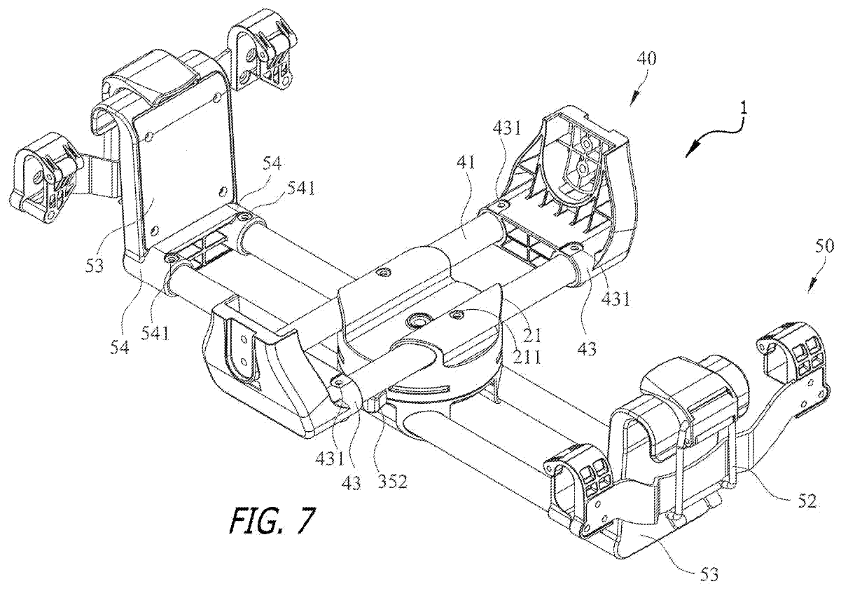

FIG. 3 shows an arrangement with upper cross bars including upper cross bar 41 and lower cross bars such as lower cross bar 51. The two ends of the at least one lower crossbar 51 fit into the at least one buckle piece, such as buckle piece 5, so that the at least one buckle piece and the bottom element 10 are generally adjacent as shown in FIG. 3. Space for placing an infant car seat is provided such as between the fixing pieces 40 in the arrangement shown. In this manner, the at least one buckle piece, such as buckle piece 50, can be attached to a frame of a baby stroller or wagon, for example, so that the connector is fixedly mounted on the baby stroller or wagon. Representations of infant baby seats affixed to a wagon are shown in FIG. 6, where the infant car seats 60 shown have been placed into the connector in the orientation of FIG. 7 and the buckle pieces 50 affixed to the wagon shown. Not viewable from the representation of FIG. 7 is the affixation of the infant car seat 60 to fixing pieces 40, where the infant car seat 60 fits snugly in fixing pieces 40. As may be appreciated from, for example, FIG. 1, the infant car seat in one embodiment may have rounded elements on its side, such as the base pivot point of rotating arms forming a handle, and such round elements fit into the U-shaped receptacle of fixing piece 40 shown in FIG. 1. In an alternate embodiment, a belt may be provided through the infant car seat 60 or with the infant car seat 60 that joins to at least one buckle member 50, or possibly both buckle members, to further secure the infant car seat 60 to the connector. A belt element may be employed to secure the infant car seat to the connector, such as by threading a seat belt type belt through the infant car seat 60 and joining the ends of the belt to the connector, such as via clip, buckle, tying, or any manner reasonable under the circumstances.

The connector can be used to fix the baby car seat on the stroller, wagon, or other appropriate device, typically having a frame. Parts may be modified to accommodate different infant car seats and/or vehicles or carriers. In the present embodiments, the infant car seat is affixed to the frame members of a stroller or wagon, but other buckle pieces may be offered to affix the connector and the infant car seat.

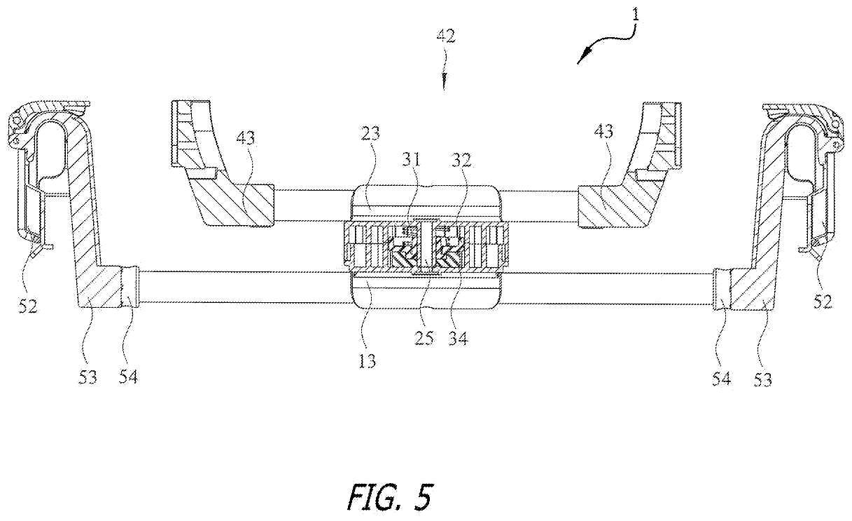

A locking arrangement may be employed to facilitate rotation of the infant car seat. Locking element 35 is shown and components that facilitate locking are shown in FIGS. 4 and 5, for example. Movement of the locking element 35 releases the turntable member 32, allowing turntable member 32 to rotate, which may occur by rotating locking element 35 and buckle seat 34. Once positioned in a desired orientation, locking element 35 may be repositioned, thus locking the top element 20 to bottom element 10. Top element 20 rotates via rotation of turntable member 32 from a first orientation to a second orientation differing from the first orientation. The top element 20 in one embodiment can be rotated from zero to 360 degrees relative to the bottom element 10.

FIG. 7 serves to show the rotated version of the connector and includes movable part 52 and fixed part 53. One side of fixed part 53 is connected with movable part 52 and serves to secure the connector to the vehicle, such as a stroller or wagon. The movable part 52 may connect with the at least one lower cross bar, when movable part 52 is positioned away from fixed part 53, and the at least one buckle piece 50 can be buckled on the baby stroller. When the movable part leans against the fixing portion, the at least one locking member can be pressed, or compressed, to fix the connector on the stroller or wagon.

Thus FIG. 1 illustrates the upper portion of the connector including fixing piece 40, upper cross bar 41, upper element 20, bottom element 10, and locking element 35. FIG. 2 is an exploded view of one embodiment of the components between top element 20 and bottom element 10, illustrating left lower hole 11, right lower hole 12, bottom base hole 13, and bottom groove 14. Above bottom groove 14 is rotation element 30 comprising buckle seat 34 attached to locking element 35 below turntable member 32 and compression spring 31. Top element 20 includes upper left hole 21 and upper right hole 22 as well as upper base 23 and shaft 25, where shaft 25 receives compression spring 31.

FIG. 3 again shows fixing piece 40, upper cross bar 41, and top element 20 with bottom element 10 provided with lower crossbar 51 and buckle piece 50. Locking element 35 is also shown in this view. FIG. 4 illustrates many of the components of FIG. 2 and adds a spring attribute in the form of fixed spring 33, with locking element 35 comprising rod 351 and protrusion 352. Hook 331 affixes fixed spring 33 to rod 351 which passes through thru hole 36. FIG. 5 is a cutaway view of the design including rotatable arrangement 42 comprising upper hollow tube 43 and upper base 23. A cutaway view of the rotating components is shown including compression spring 31 and turntable member 32 as well as shaft 25 and buckle seat 34. Also shown is the affixing mechanism to a wagon, cart, or stroller including movable part 52, fixed portion 53, and lower hollow tube 54.

FIG. 6 shows two connectors providing a connection between infant car seat 60 and stroller or wagon 61. Buckle piece 50 and frame 611 are shown. FIG. 7 is a rotated version of the connector including components from FIGS. 1 and 3, for example, as well as upper screw through hole 431, lower screw through hole 541, and left upper screw hole 211, each allowing attachment and fixation, as well as protrusion 352. FIG. 8 shows a bottom view of the design including lower crossbar 51, left lower screw hole 111, right lower screw hole 121, and lower perforation 801.

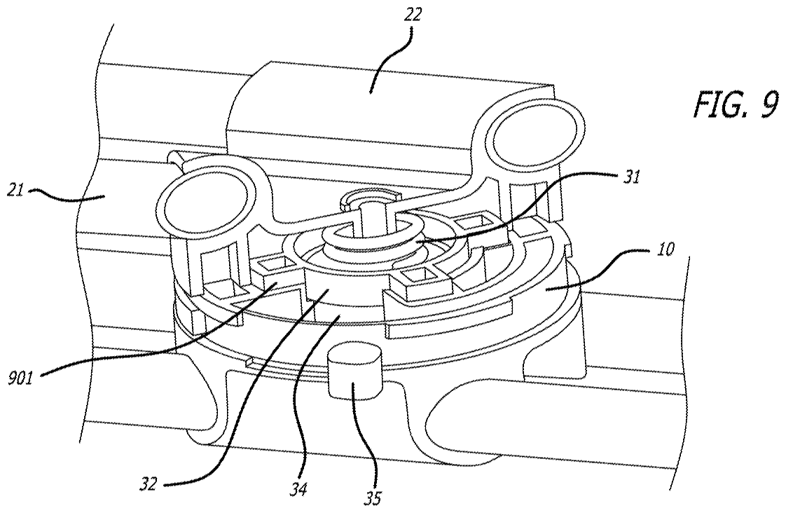

FIG. 9 is a cutaway view showing the beginning of unlocking the locking arrangement. Locking element 35 is in a first position, and joins with rod 351 (not shown in this view) which passes through the openings in bottom base 10 and contacts buckle seat 34. FIG. 2 shows a side view of these components generally but not to precise scale. Turntable member 32 is shown as is spring 31, upper left hole 21 and upper right hole 22.

In operation, when locking element 35 is moved, buckle seat 34 forces turntable member 32 upward toward spring 31, such that the four prongs of turntable member 32 lift out of the receiving openings of buckle seat 34, enabling rotation 90 degrees. Prong 901 is shown in FIG. 9, and three other similar prongs are included in the design represented in FIG. 9. While shown with four prongs and four corresponding receiving openings, more or fewer prongs and receiving elements may be offered, including two, five, six, seven, or eight, or any other reasonable number. The four prongs and corresponding receiving elements in this view are 90 degrees apart, enabling rotation of 90, 180, or 270 degrees, for example, into a second position.

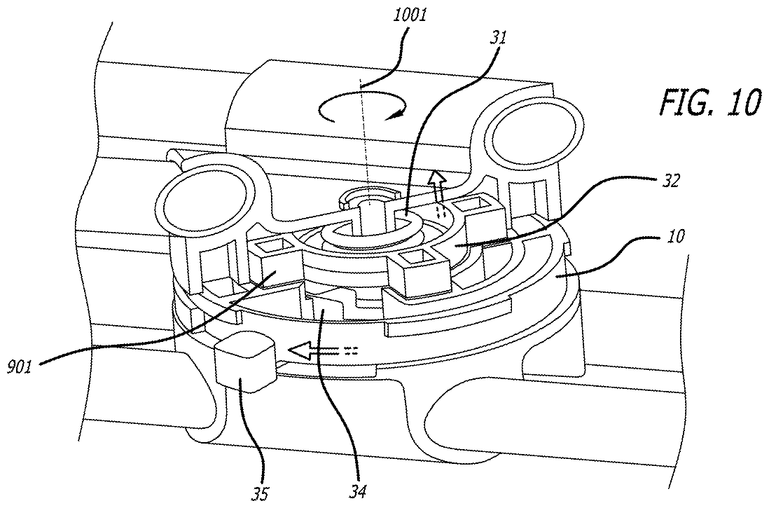

FIG. 10 shows rotation of locking element 35 counterclockwise to a second position. This rotation causes rotation of buckle seat 34, which due to its construction as shown in FIG. 2 lifts turntable member 32 upward. Rotation counterclockwise of locking element 35 is about axis 1001 and as shown in this view prong 901 lifts out from its corresponding receiving opening. At this point, the top element 20 may be rotated 90, 180, or 270 degrees in this implementation.

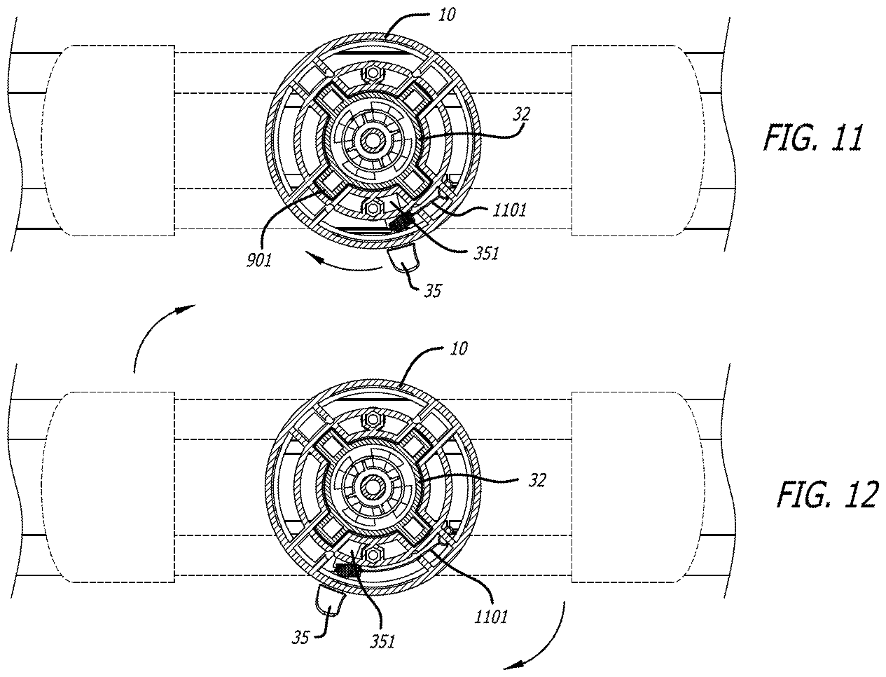

FIG. 11 is a top view of the locking arrangement, including locking element 35 in its first position similar to the representation of FIG. 9, turntable member 32, bottom element 10, prong 901, and spring 1101 which is joined to rod 351 such that when moved to the second position, as in FIG. 12, the rod 351 is drawn back to its initial first position. FIG. 12 illustrates locking element 35 in second position, rotated counterclockwise, with spring 1101 extended and rod 351 rotating buckle seat 34 (not shown in FIGS. 11 and 12) rotated such that turntable member rises upward. Again, in this configuration, the prongs are free of their respective receiving elements and the top member 20 may be rotated freely.

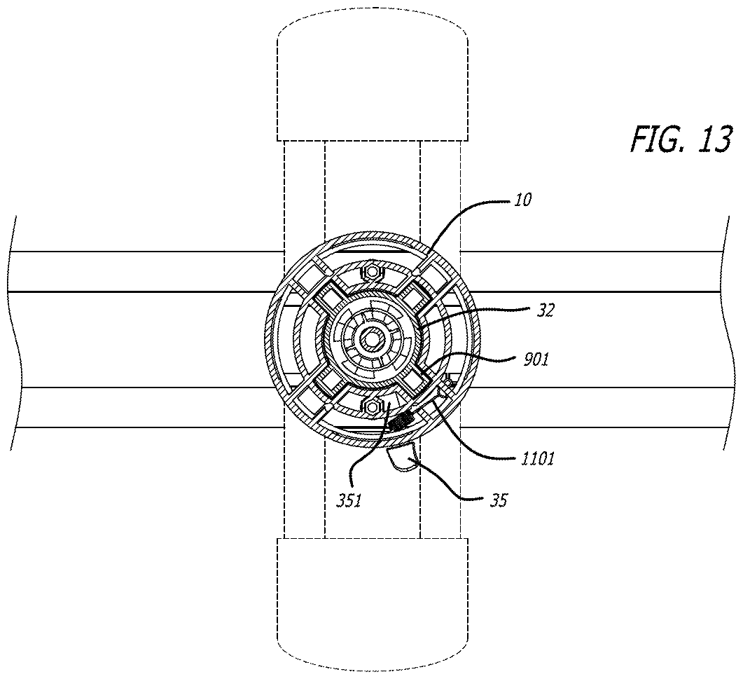

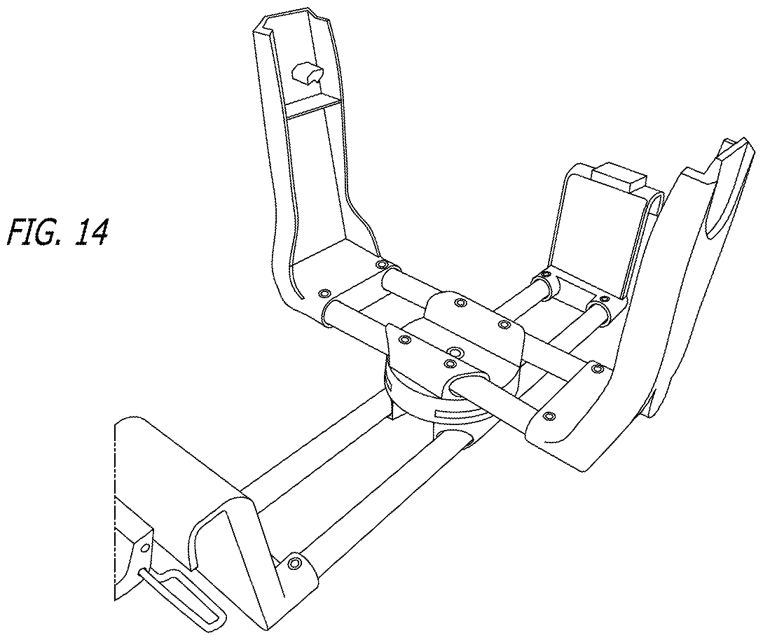

FIG. 13 presents locking element 35 moved to its initial position, spring 1101 retracted, and the top element having been rotated 90 degrees. With the locking element back in its initial position, turntable member 32 sits within bottom element 10 such that the four prongs are positioned in corresponding receiving elements in bottom element 10.

FIG. 14 is a general representation of one embodiment of alternate brackets usable to secure an alternative child car seat having a different profile and construction. Various other bracket types may be employed with the present design, and in the current design a universal connection may be provided such that different brackets may be attached to the connector and accommodate various child car seats having different dimensions. A screw or bolt may be employed to release one bracket and employ a different bracket.

### REFERENCE NUMBERS

1 connector; 10 bottom element; 11 left lower through hole; 111 left lower screw hole; 12 right bottom perforation; 121 bottom right screw hole; 13 bottom base hole; 14 bottom groove.
20 top element; 21 upper left hole; 211 left upper screw hole; 22 upper right hole; 221 upper right screw hole; 23 upper base; 24 upper groove; 25 shaft.
30 rotation element; 31 compression spring; 32 turntable member; 33 fixed spring; 331 hook; 34 buckle seat; 35 locking element; 351 rod; 352 protrusion; 36 through hole; 390 upper perforation.
40 fixing piece; 41 upper cross bar; 42 put element; 43 upper hollow tube; 431 upper screw through hole.
50 buckle piece; 51 lower cross bar; 52 movable part; 53 fixed portion; 54 lower hollow tube; 541 lower screw through hole.
60 child car seat; 61 stroller/wagon; 611 frames.
801 lower perforation.
901 prong.
1001 axis.
1101 spring.

Thus according to one embodiment, there is provided a connector usable to fix a child seat to a vehicle. The connector includes a bottom element configured to receive bottom element support members connectable to the vehicle, a top element positioned above the bottom element and configured to receive top element support members configured to receive the child seat, and a locking arrangement positioned between the bottom element and the top element, wherein the locking arrangement is configured to lock the top element to the bottom element and comprises a locking element configured to release and subsequently lock the top element such that the top element can rotate to an alternate orientation.

According to a further embodiment, there is provided a connector usable to fasten a child seat to a vehicle. The connector comprises a bottom element configured to receive a plurality of bottom supports joined to a plurality of vehicle locking elements configured to lock the connector to the vehicle, a top element positioned above the bottom element and configured to receive a plurality of top supports joined to a plurality of child seat securing elements, and a locking arrangement positioned between the bottom element and the top element, wherein the locking arrangement is configured to lock the top element to the bottom element and comprises a locking element configured to release and subsequently lock the top element such that the top element is rotatable to a second orientation.

According to another embodiment, there is provided a connector joining a child seat to a vehicle. The connector comprises a bottom element configured to receive a plurality of bottom supports and a plurality of vehicle locking elements configured to lock the connector to the vehicle, a top element positioned above the bottom element and configured to receive a plurality of top supports joined and a plurality of child seat securing elements, and a locking arrangement configured to lock the top element to the bottom element and comprising a locking element configured to release and subsequently lock the top element such that the top element is rotatable to and lockable in a second orientation.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A connector usable to fix a child seat to a vehicle, comprising:
a bottom element configured to receive bottom element support members connectable to the vehicle;
a top element positioned above the bottom element and configured to receive top element support members configured to receive the child seat; and
a locking arrangement positioned between the bottom element and the top element, wherein the locking arrangement is configured to lock the top element to the bottom element and comprises a locking element configured to release and subsequently lock the top element such that the top element can rotate to an alternate orientation.

2. The connector of claim 1, wherein the bottom element support members comprise at least one bottom crossbar connected to a buckle piece configured to attach to a support member of the vehicle.

3. The connector of claim 1, wherein the top element support members comprise at least one top crossbar connected to a fixing piece configured to receive a portion of the child seat.

4. The connector of claim 2, wherein two bottom crossbars pass through the bottom element and connect to two buckle pieces affixable to the vehicle.

5. The connector of claim 3, wherein two top crossbars pass through the top element and connect to two fixing pieces shaped to receive the child seat.

6. The connector of claim 1, wherein the locking arrangement comprises:
a turntable member configured to fit in an upper groove formed into the top element; and
a buckle seat configured to receive the turntable member and fit in a bottom groove formed into the bottom element;
wherein the buckle seat is connected to the locking element.

7. The connector of claim 4, wherein the two buckle pieces comprise:
a movable part configured to lock a first side of the connector to a support member of the vehicle; and
a fixed part configured to receive the two bottom crossbars and maintain the movable part.

8. A connector usable to fasten a child seat to a vehicle, comprising:
a bottom element configured to receive a plurality of bottom supports joined to a plurality of vehicle locking elements configured to lock the connector to the vehicle;
a top element positioned above the bottom element and configured to receive a plurality of top supports joined to a plurality of child seat securing elements; and
a locking arrangement positioned between the bottom element and the top element, wherein the locking arrangement is configured to lock the top element to the bottom element and comprises a locking element configured to release and subsequently lock the top element such that the top element is rotatable to a second orientation.

9. The connector of claim 8, wherein the plurality of bottom supports comprises a plurality of bottom crossbars fitting through the bottom element and the vehicle locking elements comprise a plurality of buckle pieces joined to the plurality of bottom crossbars and configured to attach to a support member of the vehicle.

10. The connector of claim 8, wherein the plurality of top supports comprises a plurality of top crossbars fitting through the top element and the plurality of child securing elements comprises a plurality of fixing elements attached to the plurality of top crossbars and formed to receive the child seat.

11. The connector of claim 8, wherein the locking arrangement comprises:
a turntable member configured to fit in an upper groove formed into the top element; and
a buckle seat configured to receive the turntable member and fit in a bottom groove formed into the bottom element;
wherein the buckle seat is connected to the locking element.

12. The connector of claim 9, wherein the each of the plurality of buckle pieces comprises:
a movable part configured to lock a first side of the connector to the support member of the vehicle; and
a fixed part configured to receive the two bottom crossbars and maintain the movable part.

13. The connector of claim 11, further comprising a spring positioned between the top element and the turntable member.

14. The connector of claim 12, wherein the movable part comprises a releasable clamping mechanism configured to secure the fixed portion to the support member of the vehicle.

15. A connector joining a child seat to a vehicle, comprising:
a bottom element configured to receive a plurality of bottom supports and a plurality of vehicle locking elements configured to lock the connector to the vehicle;
a top element positioned above the bottom element and configured to receive a plurality of top supports joined and a plurality of child seat securing elements; and
a locking arrangement configured to lock the top element to the bottom element and comprising a locking element configured to release and subsequently lock the top element such that the top element is rotatable to and lockable in a second orientation.

16. The connector of claim 15, wherein the plurality of bottom supports comprises a plurality of bottom crossbars fitting through the bottom element and the vehicle locking elements comprise a plurality of buckle pieces joined to the plurality of bottom crossbars and configured to attach to a support member of the vehicle.

17. The connector of claim 15, wherein the plurality of top supports comprises a plurality of top crossbars fitting through the top element and the plurality of child securing elements comprises a plurality of fixing elements attached to the plurality of top crossbars and formed to receive the child seat.

18. The connector of claim 15, wherein the locking arrangement comprises:
a turntable member configured to fit in an upper groove formed into the top element; and
a buckle seat configured to receive the turntable member and fit in a bottom groove formed into the bottom element;
wherein the buckle seat is connected to the locking element.

19. The connector of claim 16, wherein the each of the plurality of buckle pieces comprises:
a movable part configured to lock a first side of the connector to the support member of the vehicle; and
a fixed part configured to receive the two bottom crossbars and maintain the movable part.

20. The connector of claim 19, wherein the movable part comprises a releasable clamping mechanism configured to secure the fixed portion to the support member of the vehicle.
